(19) United States
(12) Patent Application Publication
(10) Pub. No.: US 2026/0005363 A1
(43) Pub. Date: Jan. 1, 2026

(54) Battery Device and Method of Manufacturing the Same

(71) Applicant: SK On Co., Ltd., Seoul (KR)

(72) Inventors: Keun Woo CHOI, Daejeon (KR); Yang Kyu CHOI, Daejeon (KR); Seo Roh RHEE, Daejeon (KR); Sung Min HONG, Daejeon (KR); Jun Hui CHO, Daejeon (KR)

(21) Appl. No.: 19/097,162

(22) Filed: Apr. 1, 2025

(30) Foreign Application Priority Data
Jul. 1, 2024 (KR) 10-2024-0086396

(51) Int. Cl. H01M 50/242; B60L 50/64; H01M 50/211; H01M 50/278; H01M 50/293

(52) U.S. Cl. CPC H01M 50/242; B60L 50/64; H01M 50/211; H01M 50/278; H01M 50/293; H01M 2220/20

(57) ABSTRACT

A battery device according to the present disclosure may include: a cell assembly having a plurality of battery cells arranged in a first direction; a case having an accommodation space in which the cell assembly is accommodated; and a surface pressure member disposed between the cell assembly accommodated in the accommodation space and the case, wherein the surface pressure member may include: an outer cover having a sealed inner space and formed of a flexible material; a support member disposed in the inner space of the outer cover; and a reinforcing frame coupled to both ends of the outer cover.

### CROSS-REFERENCE TO RELATED APPLICATION(S)

This application claims benefit of priority to Korean Patent Application No. 10-2024-0086396 filed on Jul. 1, 2024, in the Korean Intellectual Property Office, the disclosure of which is incorporated herein by reference in its entirety.

### BACKGROUND

### 1. Field

The present disclosure relates to a battery device and a method of manufacturing the same.

### 2. Description of Related Art

Secondary batteries, unlike primary batteries, may be charged and discharged, and may be applied to devices within various fields such as digital cameras, mobile phones, laptops, and hybrid cars. Secondary batteries include nickel-cadmium batteries, nickel-metal hydride batteries, nickel-hydrogen batteries, and lithium secondary batteries.

Among such secondary batteries, much research has been conducted on lithium secondary batteries having high energy density and discharge voltage, and recently, lithium secondary batteries have been manufactured as flexible pouch-type battery cells, and battery devices has been manufactured in the form of modules connecting multiple secondary batteries.

When a plurality of battery cells are disposed in a single case, if one battery cell is expanded, surface pressure is not evenly applied to the other battery cells, and a surface pressure deviation may cause deterioration of the battery cells.

### SUMMARY

An aspect of the present disclosure is to provide a battery device of suppressing deterioration of a battery cell due to a surface pressure deviation and a method of manufacturing the same.

A battery device of the present disclosure may be widely applied to use in electric vehicles and battery charging stations, and green technology fields such as solar power generation and wind power generation using other batteries. Additionally, a battery case of the present disclosure may be used in eco-friendly electric vehicles, hybrid vehicles, and the like, in order to prevent climate change by suppressing air pollution and greenhouse gas emissions.

A battery device according to the present disclosure may include: a cell assembly having a plurality of battery cells arranged in a first direction; a case having an accommodation space in which the cell assembly is accommodated; and a surface pressure member disposed between the cell assembly accommodated in the accommodation space and the case, and the surface pressure member may include: an outer cover having a sealed inner space and formed of a flexible material; a support member disposed in the inner space of the outer cover; and a reinforcing frame coupled to both ends of the outer cover.

According to an embodiment, the support member may be disposed to face one side surface of the cell assembly, and the reinforcing frame may be disposed in a region that does not face the battery cell.

According to an embodiment, the reinforcing frame may have an insertion groove formed in one surface thereof facing the outer cover, and an insertion portion inserted into the insertion groove may be formed on both ends of the outer cover.

According to an embodiment, the insertion portion may include: an extension portion extending into an interior of the reinforcing frame in a longitudinal direction of the surface pressure member; and an expansion portion expanded in a thickness direction of the surface pressure member from an end of the extension portion.

According to an embodiment, the reinforcing frame may be formed of a metal material.

According to an embodiment, the support member may be formed to have an area wider than one side surface of the cell assembly and may be disposed to face an entirety of one side surface of the cell assembly.

According to an embodiment, the support member may include one of a silicone gel, a thermosetting plastic, a foam plastic, and a cellular plastic.

According to an embodiment, the outer cover may include rubber or a synthetic resin.

According to an embodiment, the outer cover may include an injection port through which the support member in a liquid phase is injected into the inner space of the outer cover, and the injection port is sealed after the support member in a liquid phase is injected.

According to an embodiment, the case may include: a side wall portion forming a side surface of the case; and a partition wall disposed inside the side wall portion to partition the accommodation space, and a height of the support member may be formed to be higher than the cell assembly and lower than a height of the side wall portion or the partition wall.

Additionally, a method of manufacturing a battery device according to the present disclosure may include: disposing a cell assembly in which a plurality of battery cells are arranged in a first direction, within an accommodation space of a case; inserting and disposing an outer cover between the case and the cell assembly; injecting a support member in a liquid phase into an interior of the outer cover; curing the support member in the liquid phase.

According to an embodiment, the inserting and disposing an outer cover may include: coupling a reinforcing frame to both ends of the outer cover; and inserting and disposing the outer cover to which the reinforcing frame is coupled, between the case and the cell assembly.

According to an embodiment, the support member in the liquid phase may be injected into the interior of the outer cover through an injection port formed in the outer cover, and the method may further include, after the injecting the support member in the liquid phase, sealing the injection port.

According to an embodiment of the present disclosure, since a surface pressure member is disposed between a cell assembly and a case, it may be possible to minimize a surface pressure deviation caused by battery cell swelling.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a battery device according to an embodiment of the present disclosure;

FIG. 2 is a partial exploded perspective view of FIG. 1;

FIG. 3 is a partially cross-sectional view taken along line I-I′ of FIG. 1;

FIG. 4 is a partially cross-sectional view taken along line II-II′ of FIG. 3;

FIG. 5 is an enlarged view of portion A of FIG. 4;

FIG. 6 is an exploded perspective view of the surface pressure member illustrated in FIG. 2;

FIGS. 7 and 8 are views illustrating a method of manufacturing a battery device according to an embodiment;

FIG. 9 is a flowchart of a method of manufacturing a battery device according to an embodiment.

### DETAILED DESCRIPTION

Hereinafter, the present disclosure will be described in detail with reference to the accompanying drawings. However, this is illustrative only and the present disclosure is not limited to the specific embodiments illustrated exemplarily.

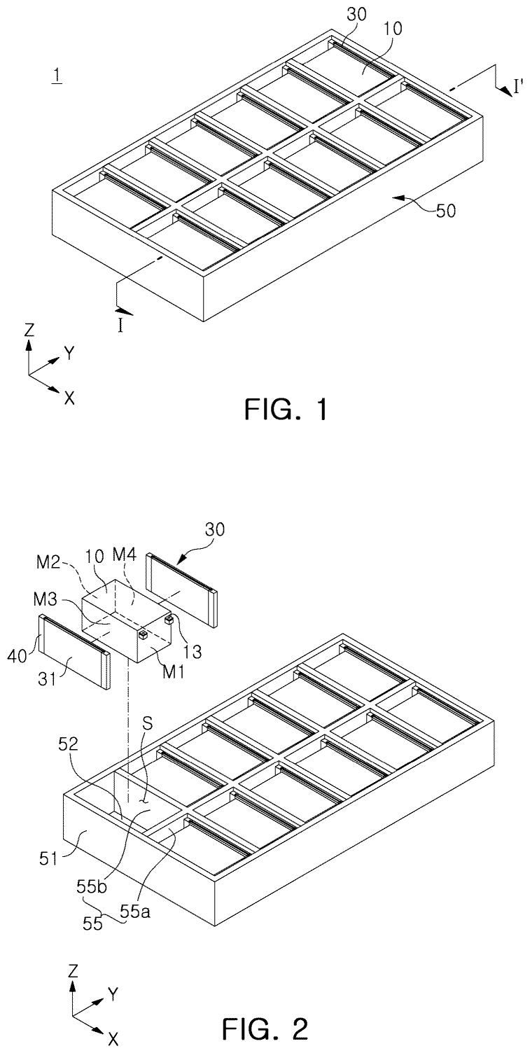

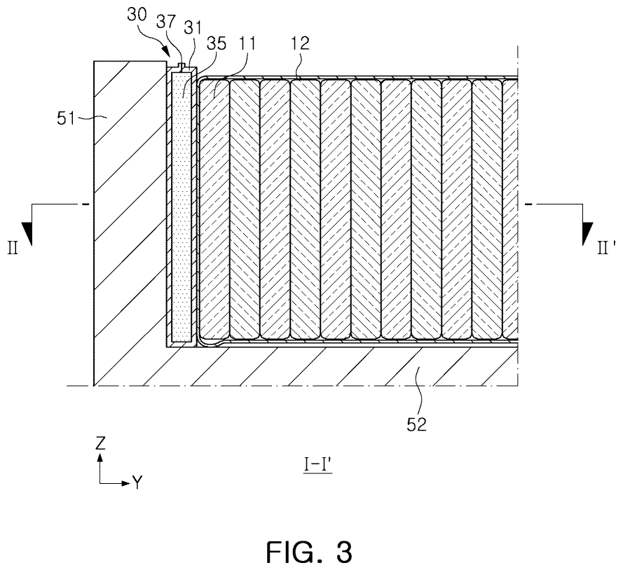

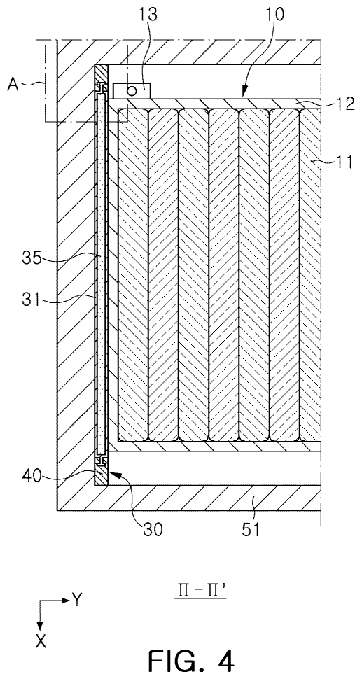

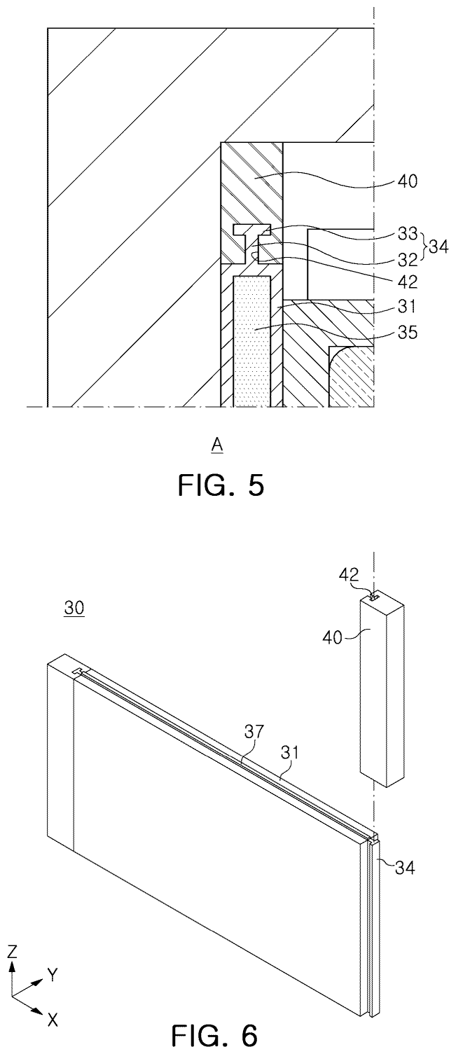

FIG. 1 is a perspective view schematically illustrating a battery device according to an embodiment of the present disclosure, and FIG. 2 is a partially exploded perspective view of FIG. 1. Furthermore, FIG. 3 is a cross-sectional view taken along line I-I′ of FIG. 1, FIG. 4 is a cross-sectional view taken along line II-II′ of FIG. 3, and FIG. 5 is an enlarged view of portion A of FIG. 4.

Referring to FIGS. 1 to 5, a battery device 1 according to an embodiment of the present disclosure may include a cell assembly 10 in which a plurality of battery cells 11 are arranged in a first direction (e.g., Y-direction), a case 50 having an accommodation space in which the cell assembly 10 is accommodated, and a surface pressure member 30 disposed between the cell assembly 10 accommodated in the accommodation space S and the case 50.

The cell assembly 10 may include a battery cell 11 capable of being charged or discharged therein or therefrom, such as a lithium battery or a nickel-hydrogen battery. Each cell assembly 10 may be formed into an approximately hexahedral shape by arranging a plurality of battery cells 11 in the first direction, and may be accommodated in a separate housing 12 or may be fixed in a close state by a bracket or the like.

Accordingly, the cell assembly 10 may include four side surfaces M1, M2, M3 and M4. The four side surfaces M1, M2, M3 and M4 may include a first side surface M1 on which a terminal 13 is disposed, a second side surface M2 which is an opposite surface of the first side surface, and a third side surface M3 and a fourth side surface M4 disposed in both ends in an arrangement direction of the battery cells 11.

The terminal 13 may be a conductive member exposed to the outside of the cell assembly 10 so as to electrically connect the battery cells 11 to the outside, and may include a positive electrode terminal and a negative electrode terminal. In this embodiment, a case in which both the positive electrode terminal and the negative electrode terminal are disposed on the first side surface M1 is given as an example, but this embodiment is not limited thereto. For example, at least one terminal may also be disposed on the second side surface M2.

The third side surface M3 and the fourth side surface M4 are two side surfaces forming opposite directions and may be side surfaces orthogonal to the first side surface M1 and the second side surface M2.

Since the third side surface M3 and the fourth side surface M4 form side surfaces in both ends in the first direction, which is the arrangement direction of the battery cells 11, the third side surface M3 and the fourth side surface M4 may refer to side surfaces disposed to be parallel to a surface direction of the battery cells 11.

The case 50 may provide an accommodation space S accommodating other components inside. Accordingly, the case 50 may be provided in a form surrounding the entire cell assemblies 10, and a plurality of cell assemblies 10 may be disposed in parallel by forming at least one row within the accommodation space S of the case 50.

The case 50 may be formed of a metal material to secure rigidity, but the present disclosure is not limited thereto. Additionally, at least a portion of the case 50 may be formed of aluminum to enhance the heat dissipation effect.

The case 50 may include a side wall portion 51 forming a side surface and a lower plate 52 covering a lower portion of the accommodation space S, and although not illustrated, the case 50 may further include an upper plate covering the upper portion of the accommodation space S. Additionally, the case 50 of this embodiment may include a partition wall 55 coupled to the side wall portion 51 to partition the accommodation space S inside the side wall portion 51.

The side wall portion 51 may form an outer surface of the case 50 and may define an inner space of the case 50. Accordingly, the cell assemblies 10 may be accommodated within an inner space defined by the side wall portion 51 and may be settled on the lower plate 52.

The lower plate 52 may support a lower surface of the cell assemblies 10. The partition wall 55 may be disposed by intersecting the inner space formed by the side wall portion 51 to divide the inner space into a plurality of accommodation spaces S. Accordingly, the plurality of cell assemblies 10 may be distributed and disposed in each of the plurality of accommodation spaces S divided by the side wall portion 51 and the partition wall 55.

At least a portion of the partition wall 55 may be fastened to the side wall portion 51, thereby reinforcing the overall rigidity of the case 50. Additionally, the partition wall 55 may be disposed between the cell assemblies 10 to prevent gas or flames from spreading between the cell assemblies 10.

The partition wall 55 of an embodiment may include at least one first partition wall 55a disposed to be parallel to a width direction (Y-direction) of the cell assemblies 10, and at least one second partition wall 55b disposed to be parallel to a length direction (X-direction) of the cell assemblies 10.

The surface pressure member 30 may be disposed between a side surface of the cell assembly 10 and the case 50. The surface pressure member 30 may be provided to provide surface pressure to the battery cells 11 included in the cell assembly 10. Accordingly, the surface pressure member 30 may be disposed to face the third side surface M3 and the fourth side surface M4 among the side surfaces of the cell assembly 10 in which surface pressure is required.

FIG. 6 is an exploded perspective view of the pressure member illustrated in FIG. 2.

Referring to FIG. 6 together, the surface pressure member 30 of an embodiment may include an outer cover 31 having a sealed inner space and formed of a flexible material, a support member 35 disposed in the inner space of the outer cover 31, and a reinforcing frame 40 coupled to both ends of the outer cover 31.

The outer cover 31 may form an entire outer shape of the surface pressure member 30 and may be formed as an outer material wrapping the support member 35 inside. The outer cover 31 may be formed of a flexible sheet material.

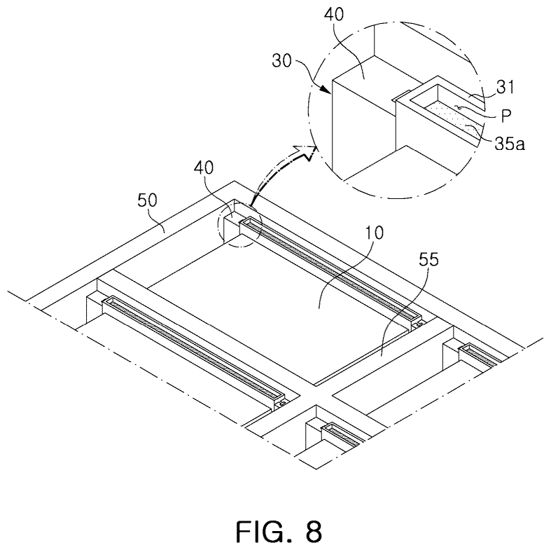

During the manufacturing process of the surface pressure member 30, a support member in a liquid phase (35a of FIG. 8, hereinafter referred to as a liquid member) may be injected into the inner space of the outer cover 31 of an embodiment. Accordingly, the outer cover 31 of this embodiment may be formed of a waterproof material preventing a liquid member 35a injected inside from leaking out.

The liquid member 35a may increase in volume during a curing process. In response thereto, the outer cover 31 may be formed of a material capable of elastic deformation. Additionally, since the liquid member 35a may be at a high temperature, the outer cover 31 may be formed of a material capable of withstanding the high temperature. For example, the outer cover 31 may be formed of a non-metallic material and may include rubber or synthetic resin. However, this embodiment is not limited thereto.

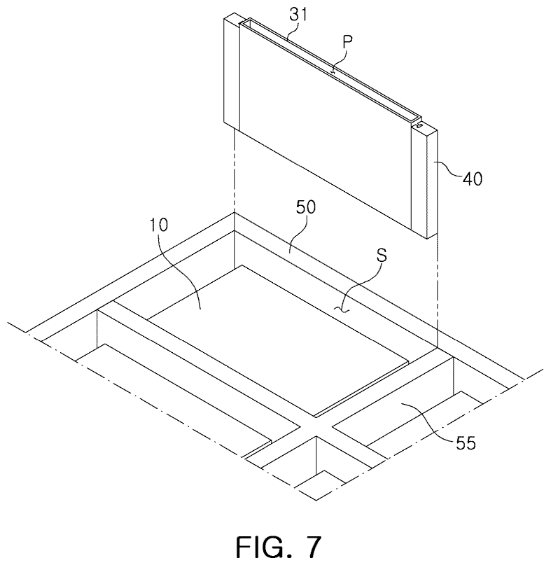

In order to inject the liquid material 35a into an interior of the outer cover 31, an injection port (P in FIG. 7) through which the liquid material 35a is injected into the inner space of the outer cover 31 may be formed in the outer cover 31. After the liquid material 35a is completely injected into the outer cover 31, the injection port P may be sealed to form a sealing portion 37. Accordingly, the injection port P may be formed in a form that may be closed or blocked after the liquid material 35a is injected. In this case, the injection port P may be mechanically sealed or chemically sealed.

For example, the injection port P may be formed by opening one surface (an upper surface in FIG. 6) of the outer cover 31. In this case, the sealing portion 37 may be formed by heat-melting or mutually bonding an injection port P portion of the outer cover 31. However, this embodiment is not limited thereto. For example, it may also be possible to form the injection port P in a tube shape or a check valve shape.

The reinforcing frame 40 described below may be coupled to both ends of the outer cover 31 in a longitudinal direction, and for this purpose, the outer cover 31 may include an insertion portion 34.

The insertion portion 34 is a portion inserted into an insertion groove 42 formed in the reinforcing frame 40, and may include an extension portion 32 extending into an interior of the reinforcing frame 40 in a longitudinal direction (X-direction in FIG. 4, hereinafter referred to as a second direction) of the surface pressure member 30 and an expansion portion 33 expanded in a thickness direction (Y-direction in FIG. 4) of the surface pressure member 30 from an end of the extension portion 32. For example, the insertion portion 34 may be formed in a ‘T’ shape in a cross-section, and the reinforcing frame 40 may have an insertion groove 42 formed to correspond thereto.

The reinforcing frame 40 may be coupled to the insertion portion 34 in an up-down direction (Z-direction of FIG. 6, hereinafter the third direction), and the reinforcing frame 40 coupled to the insertion portion 34 may not be easily separated in the first direction or the second direction by the insertion portion 34.

The support member 35 may be disposed in the inner space of the outer cover 31, and when the volume of the cell assembly 10 expands due to swelling of the battery cell 11, the support member 35 may support the side surface of the cell assembly 10 and may provide surface pressure to the side surface of the cell assembly 10.

As described above, the support member 35 of this embodiment may be formed by injecting a liquid member into the interior of the outer cover 31 and then curing the liquid member. Accordingly, the support member 35 may be formed of a material capable of changing into a liquid phase and maintaining a solid state at an operating temperature of the battery cell 11.

The support member 35 of this embodiment may be formed of a material having a small change in volume during caring (e.g., silicone gel, thermosetting plastic, and the like), or may be formed of a material having a large change in volume during curing (e.g., plastic foam, cellular plastic, and the like). Here, the thermosetting plastic may include an epoxy resin used for potting. Accordingly, the support member 35 of this embodiment may include one of silicone gel, thermosetting plastic, foam plastic, and cellular plastic.

When a material having a large volume change during caring is used as the support member 35, the amount of the liquid member injected into the outer cover 31 may be determined based on an expanded volume during caring.

As the support member 35 is injected into the inside of the outer cover 31 in a liquid phase and then cared, the support member 35 may be formed in a shape filling a space between the cell assembly 10 and the case 50. Accordingly, the shape of the support member 35 may be formed in a shape corresponding to the shape of the space between the cell assembly 10 and the case 50.

Additionally, in an embodiment, the support member 35 may be formed to have an area wider than one side surface of the cell assembly 10 and may be disposed to face an entirety of one side surface of the cell assembly 10. For example, the support member 35 may be disposed to entirely support the electrode assembly disposed inside the battery cell 11. Accordingly, the support member 35 may have a larger area than the third side surface M3 or the fourth side surface M4 of the cell assembly 10, and the third side surface M3 or the fourth side surface M4 of the cell assembly 10 may be disposed so that the entirety of the third side surface M3 or the fourth side surface M4 faces the support member 35 or the outer cover 31.

On the other hand, when an area of the support member 35 is excessively large, interference between the surface pressure member 30 and the case 50 may occur. Accordingly, in order to prevent such interference, a height of the support member 35 may be formed to be higher than the cell assembly 10 and lower than a height of the side wall portion of the case 50 or the partition wall 55. Additionally, a length of the support member 35 may be smaller than a length of the accommodation space in which the cell assembly 10 is disposed.

The reinforcing frame 40 may be coupled to both ends of the outer cover 31 to reinforce the rigidity of the outer cover 31.

The reinforcing frame 40 may be provided to prevent deformation of an outer shape of the outer cover 31 having ductility. When the liquid material 35a is injected into the outer cover 31, the outer shape of the outer cover 31 may be deformed by the flow of the liquid material 35a. For example, in the process of injecting the liquid material 35a, the outer cover 31 may move toward the first side surface M1 or the second side surface M2 of the cell assembly 10 due to the flow of the liquid material 35a and may deviate from an original position thereof. Accordingly, in order to prevent the outer cover 31 from being deviated from the original position, the reinforcing frame 40 may be coupled to both ends of the outer cover 31.

The reinforcing frame 40 may be formed in a block shape having a rectangular parallelepiped shape, and one side surface thereof may be coupled to an end of the outer cover 31. The reinforcing frame 40 of an embodiment may have the insertion groove 42 formed in one surface facing the outer cover 31, and an insertion portion 34 inserted into the insertion groove 42 may be formed on both ends of the outer cover 31.

The insertion portion 34 may be formed in a shape corresponding to the insertion groove 42. In an embodiment, both the insertion groove 42 and the insertion portion 34 may be formed to have a cross-section of a ‘T’ shape. However, this embodiment is not limited thereto, and as long as the reinforcing frame 40 may be firmly connected to the outer cover 31, the insertion portion 34 and the insertion groove 42 may be changed into various shapes.

The reinforcing frame 40 may be formed to have a thickness that is equal to or similar to that of the outer cover 31 in which the support member 35 is accommodated. The reinforcing frame 40 of an embodiment may be formed of a material that is not easily deformed in a process in which the support member 35 in the liquid phase is cured. For example, the reinforcing frame 40 may be formed of a metal material. However, this embodiment is not limited thereto. Meanwhile, the reinforcing frame 40 and the supporting member 35 may have different rigidity or elasticity. Accordingly, when the reinforcing frame 40 is disposed to face the cell assembly 10, different surface pressures may be applied to a portion of the cell assembly 10 that faces the reinforcing frame 40 and the portion of the cell assembly that faces the supporting member 35. When there is a deviation in the surface pressure applied to the battery cell, this may cause deterioration of the battery cell. Accordingly, the reinforcing frame 40 of this embodiment may be disposed so as not to come into contact with the third and fourth side surfaces M3 and M4 of the cell assembly 10. For example, the surface pressure member 30 may be disposed so that the supporting member 35 faces one side surface of the cell assembly 10, and the reinforcing frame 40 may be disposed in a region that does not face the battery cell 11.

Next, a method of manufacturing a battery device according to an embodiment will be described.

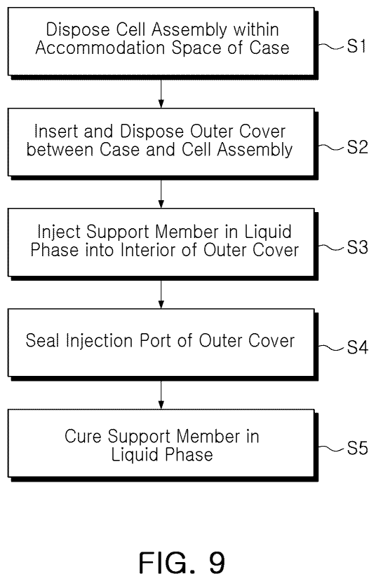

FIGS. 7 and 8 are views illustrating a method of manufacturing a battery device according to an embodiment, and FIG. 9 is a flow chart of a method of manufacturing a battery device according to an embodiment.

Referring to FIGS. 6 to 9 together, the method of manufacturing a battery device according to an embodiment may include an operation (S1) of disposing a cell assembly 10 in which a plurality of battery cells 11 are arranged in a first direction in an accommodation space S of a case 50, an operation (S2) of inserting and disposing an outer cover 31 between the case 50 and the cell assembly 10, an operation (S3) of injecting a support member 35a in a liquid phase into an interior of the outer cover 31, and an operation (S5) of curing the support member 35a in a liquid phase.

The manufacturing method according to an embodiment may first perform an operation (S1) of disposing a cell assembly 10 in an accommodation space of a case 50. A plurality of cell assemblies 10 may be settled in the corresponding accommodation space S. In this case, the third side surface M3 and the fourth side surface M4 of the cell assembly 10 may be spaced apart from the partition wall 55 or the side wall portion 51 by a certain distance.

Next, an operation (S2) of inserting and disposing an outer cover 31 between the cell assembly 10 and the case 50 may be performed. This operation may include an operation of coupling a reinforcing frame 40 to both ends of the outer cover 31 and an operation of inserting and disposing the outer cover 31 to which the reinforcing frame 40 is coupled, between the case 50 and the cell assembly 10.

Accordingly, in this operation, an inner portion of the outer cover 31 may be empty, and the outer cover 31 may be in a state where the reinforcing frame 40 is coupled to both ends thereof. The outer cover 31 may be disposed in a space between the third side surface (M3 of FIG. 2) of the cell assembly 10 and the partition wall 55 or the side wall portion 51, and a space between the fourth side surface (M4 of FIG. 2) of the cell assembly 10 and the partition wall 55 or the side wall portion 51, respectively.

Then, an operation (S3) of injecting a liquid material 35a into the interior of the outer cover 31 through an injection port P of the outer cover 31 may be performed. The liquid material 35a may fill a space between the cell assembly 10 and the case 50 while being injected into the interior of the outer cover 31. Then, as the liquid material 35a is cured, a volume thereof may be expanded to provide surface pressure toward the cell assembly 10.

Then, an operation (S4) of sealing the injection port P to seal the inner space of the outer cover 31 may be performed. The injection port P may be mechanically sealed or chemically sealed. Meanwhile, when the injection port P is configured as a check valve, a function of the check valve itself may prevent the liquid member 35a injected into the outer cover 31 from flowing back. Accordingly, in this case, this operation may be omitted.

Additionally, the manufacturing method of an embodiment may include an operation (S5) of curing the liquid support member 35a. The liquid support member 35a may be cured while a temperature thereof is gradually lowered in a state of being injected into the outer cover 31. In this case, this operation may be performed by a method of lowering the temperature of the liquid member 35a after the operation (S3) of injecting the liquid member 35a into the outer cover 31.

Meanwhile, this embodiment exemplifies a case in which the operation (S5) of curing the liquid support member 35a is performed after the operation (S4) of sealing the injection port P, but this embodiment is not limited thereto. For example, the operation (S5) of curing the liquid support member 35a may be performed before the operation (S4) of sealing the injection port P. That is, the manufacturing method of this embodiment may seal the injection port P after the liquid member 35a is cured.

The battery device of this embodiment described above may minimize a surface pressure deviation caused by battery cell swelling because the surface pressure member is disposed between the cell assembly and the case, thereby improving the lifespan and performance of the battery cell.

Additionally, in the surface pressure member of this embodiment, the outer cover is first disposed between the cell assembly and the case, and then the outer cover is filled with the liquid member, so that the cell assembly and the case may be easily assembled.

Additionally, even if a gap formed between the cell assembly and the case is narrow, the surface pressure member may be easily disposed within the gap.

Additionally, since the volume of the liquid member may increase during the curing process, sufficient surface pressure may be provided to the cell assembly.

Additionally, since reinforcing brackets are coupled to both ends of the outer cover, the insufficient rigidity of the outer cover may be reinforced, and thus the movement of the outer cover may be suppressed during the liquid material injection process.

The embodiment of the present disclosure has been described in detail above, the scope of the present disclosure is not limited thereto, and it will be obvious to those skilled in the art that various modifications and changes may be made therein without departing from the technical spirit of the present disclosure as defined by the appended claims.

What is claimed is:

1. A battery device, comprising:
a cell assembly having a plurality of battery cells arranged in a first direction;
a case having an accommodation space in which the cell assembly is accommodated; and
a surface pressure member disposed between the cell assembly accommodated in the accommodation space and the case,
wherein the surface pressure member includes:
an outer cover having a sealed inner space and formed of a flexible material;
a support member disposed in the inner space of the outer cover; and
a reinforcing frame coupled to both ends of the outer cover.

2. The battery device according to claim 1, wherein the support member is disposed to face one side surface of the cell assembly, and
the reinforcing frame is disposed in a region that does not face the battery cell.

3. The battery device according to claim 2, wherein the reinforcing frame has an insertion groove formed in one surface thereof facing the outer cover, and
an insertion portion inserted into the insertion groove is formed on both ends of the outer cover.

4. The battery device according to claim 3, wherein the insertion portion includes:
an extension portion extending into an interior of the reinforcing frame in a longitudinal direction of the surface pressure member; and
an expansion portion expanded in a thickness direction of the surface pressure member from an end of the extension portion.

5. The battery device according to claim 2, wherein the reinforcing frame is formed of a metal material.

6. The battery device according to claim 2, wherein the support member is formed to have an area wider than one side surface of the cell assembly and is disposed to face an entirety of one side surface of the cell assembly.

7. The battery device according to claim 1, wherein the support member includes one of a silicone gel, a thermosetting plastic, a foam plastic, and a cellular plastic.

8. The battery device according to claim 1, wherein the outer cover includes rubber or a synthetic resin.

9. The battery device according to claim 1, wherein the outer cover includes an injection port through which the support member in a liquid phase is injected into the inner space of the outer cover, and
the injection port is sealed after the support member in the liquid phase is injected.

10. The battery device according to claim 1, wherein the case includes:
a side wall portion forming a side surface of the case; and
a partition wall disposed inside the side wall portion to partition the accommodation space,
wherein a height of the support member is formed to be higher than the cell assembly and lower than a height of the side wall portion or the partition wall.

11. A method of manufacturing a battery device, comprising:
disposing a cell assembly in which a plurality of battery cells are arranged in a first direction, within an accommodation space of a case;
inserting and disposing an outer cover between the case and the cell assembly;
injecting a support member in a liquid phase into an interior of the outer cover;
curing the support member in the liquid phase.

12. The method of manufacturing a battery device according to claim 11, wherein the inserting and disposing an outer cover includes:
coupling a reinforcing frame to both ends of the outer cover; and
inserting and disposing the outer cover to which the reinforcing frame is coupled, between the case and the cell assembly.

13. The method of manufacturing a battery device according to claim 11, wherein the support member in the liquid phase is injected into the interior of the outer cover through an injection port formed in the outer cover, and
the method further includes, after the injecting the support member in the liquid phase, sealing the injection port.
